(19) United States
(12) Patent Application Publication
(10) Pub. No.: US 2011/0231793 A1
(43) Pub. Date: Sep. 22, 2011

(54) USER INTERFACE SELECTION MODES

(75) Inventor: STEWART WILSON, LANCASHIRE (GB)

(73) Assignee: PROMETHEAN LTD, Lancashire (GB)

(21) Appl. No.: 12/725,920

(22) Filed: Mar. 17, 2010

(51) Int. Cl. G06F 3/048

(52) U.S. Cl. 715/810; 715/862

(57) ABSTRACT

There is disclosed a method of controlling a user interface comprising the steps of: positioning a cursor over a displayed object and dragging the cursor; and determining a state of a mode of operation, wherein: in a first state, the object under the cursor is dragged with the cursor; and in a second state, a selection area is dragged with the cursor.

### BACKGROUND TO THE INVENTION

1. Field of the Invention

The invention relates to an improved user interface, and particularly but not exclusively to a user interface presented in combination with an interactive display surface.

2. Description of the Related Art

Interactive display systems are well-known. In an interactive display system, a user (or users) interact with a display surface on which an image is projected. In one known environment, the interactive display surface may be a display surface of an electronic whiteboard, which is used in a classroom environment for educational purposes.

In such systems, the user stands at or close to the display surface, and interacts with the display surface. Different types of interactive display surface are possible, and the user may interact with the surface by using a finger in a touch-sensitive system, or by using a pointer. Where a pointer is used, the interaction between the pointer and the display surface may be by means other than touch-sensitive means.

In such systems, the use of the pointer (or finger) at the interactive display surface may be for the same purpose as a mouse in a desktop computer system. The user uses the pointer to control a cursor displayed on the display screen, and to select icons and tools displayed on the display screen. In this way the user can manipulate the information displayed in the same manner as they may manipulate information using a desktop computer, but the manipulation takes place at the display on which information is displayed to a classroom. In this way the display is an electronic whiteboard.

It is known in the art to provide pointers for use with such interactive display systems with buttons, which buttons can be used to simulate “mouse clicks”. It is also known in the art to use pressure-sensitive pointers, which can be used to simulate “mouse clicks”.

Whilst there is provided in the art pointers which are adapted to allow the functionality of a mouse to be replicated, when a user is using a desktop computer they may also use one or more keyboard keys in combination with using a mouse or mouse buttons to select certain functionality. In an interactive display system, the use of the keyboard is generally not possible, and is generally undesirable as the purpose of the interactive display is for the user to be able to stand at or close to the display surface and not use a keyboard.

Furthermore there is a need in the art to provide a greater degree of control over certain functionality. In the art certain default actions may be implemented in a given circumstance, with no possibility to control or modify such default action.

It is an aim of the invention to provide a technique which addresses one or more of the above-stated problems.

### SUMMARY OF THE INVENTION

In one aspect the invention provides a method of controlling a user interface comprising the steps of: positioning a cursor over a displayed object and dragging the cursor; and determining a state of a mode of operation, wherein: in a first state, the object under the cursor is dragged with the cursor; and in a second state, a selection area is dragged with the cursor.

The selection area may be a marquee selection box. In said second state any item which intersects the selection area may be selected. In said second state any item which is contained within the selection area may be selected.

The mode of operation may be toggled between the first and second states.

The state of said mode may be toggled by selection of any one of: an icon of a graphical user interface; a keypad of a keyboard; or a button of a pointing device.

The method may comprise determining the state of a further mode of operation when a selection area is formed, comprising: in a first state of said further mode, any object selected by the selection area replaces one or more previously selected objects; in a second state of said further mode, any object selected by the selection area is added to or removed from a selection set.

In the second state of the further mode if an object selected by the selection area is already in said selection set, it may be removed from said selection set. In the second state of the further mode if an object selected by the selection area is not in said selection set, it may be added to said selection set.

The cursor may be controlled by a pointer on an interactive display surface.

In another aspect the invention may provide a computer system comprising: means for positioning a cursor over a displayed object and dragging the cursor; and means for determining a state of a mode of operation, wherein: in a first state, the object under the cursor is dragged with the cursor; and in a second state, a selection area is dragged with the cursor.

In another aspect the invention may provide method of controlling a user interface comprising the step of: defining a selection set, being a set of one or more selected objects; selecting an object; and determining a state of a mode of operation, wherein: in a first state any selected object forms the selection set; and in a second state any selected object is added to or moved from the selection set.

The step of selecting an object may comprise: dragging a cursor on a display over one or more displayed objects to define a selection area; and wherein the steps of determining the state of the mode of operation includes: in the first state any object determined to be in the selection area forms the selection set; in the second state any object determined to be in the selection area is added to or removed from the selection set.

In the second state any selected object determined to be in the selection set may be removed from the selection set. In the second state any selected object determined to not be in the selection set may be added to the selection set.

In the first state any selected object may replace any object in the selection set.

Any object which is encompassed by the selection area may be defined to be in the selection area.

Any object which intersects the selection area may be defined to be in the selection area.

The method may further comprise the step of determining a state of a preliminary mode of operation, wherein in a first state of said preliminary mode of operation an object under the cursor is dragged as the cursor is dragged, and in a second state of said preliminary mode of operation the selection area is defined.

In another aspect the invention may provide a computer system comprising: means for defining a selection set, being a set of one or more selected objects; means for selecting an object; and means for determining a state of a mode of operation, wherein: in a first state any selected object forms the selection set; and in a second state any selected object is added to or moved from the selection set.

### BRIEF DESCRIPTION OF THE FIGURES:

The invention will now be described by way of example with reference to the accompanying figures in which:

FIG. 1 illustrates an exemplary interactive display system in which embodiments of the invention may be implemented;

FIGS. 2a and 2b illustrate a first mode of operation in a first state at a user interface in accordance with an exemplary embodiment of the invention;

FIGS. 2c and 2d illustrate the first mode of operation in a second state at a user interface in accordance with an exemplary embodiment of the invention;

FIG. 3 illustrates a second mode of operation in either a first or second state at a user interface in accordance with an exemplary embodiment of the invention;

FIG. 4 illustrates a third mode of operation in either a first or second state at a user interface in accordance with an exemplary embodiment of the invention;

FIG. 5 illustrates an exemplary flow diagram for an exemplary implementation of the invention; and

FIG. 6 illustrates an exemplary computer system architecture identifying the means for implementing embodiments of the invention.

### DESCRIPTION OF THE PREFERRED EMBODIMENTS:

The invention is described herein by way of reference to specific preferred embodiments and implementations. One skilled in the art will appreciate that the invention is not limited to the specifics of any arrangement described herein. In particular the invention is described herein in the context of an exemplary interactive display system, and one skilled in the art will appreciate that the invention is not limited to the specifics of the described interactive display system. The invention is in general advantageously applicable to any arrangement in which a pointing device (which may be a physical device, a user's finger) interacts with a display surface, but is not limited to such arrangements.

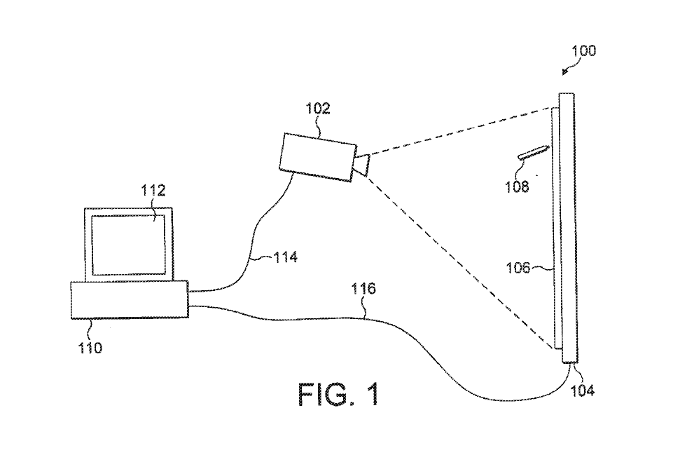

With reference to FIG. 1, there is illustrated an interactive display system 100 within which a user interface adapted in accordance with the principles of the invention may advantageously be used. The interactive display system 100 includes a projector 102, a display board 104 having a display surface 106, a pointer 108, and a computer 110 having an associated display 112. The computer 110 is connected to the projector 102 via a communication link 114, and is connected to the display device 104 by a connection 116.

The operation of interactive display systems such as that illustrated in FIG. 1 are well-known to those skilled in the art. In general, the projector 102 is controlled by the computer 110 to project onto the display surface 106 images. A user uses a pointer 108 to manipulate the images displayed on the display surface 106. For example the user may use the pointer 108 in the way that a mouse of a computer system is used, to move a cursor around the display surface, and to select objects displayed on the display surface. Although a pointer is illustrated in FIG. 1, in alternative interactive display systems a user's finger may be used to manipulate images on the display surface. In general the pointer 108 may be considered a pointing means, which term encompasses a physical device or a user's finger. The interactive display surface may be a touch-sensitive surface, or any other type of interactive surface. The display device 104 is adapted to operate in combination with the computer system 110 to determine the location of the pointer 108 on the display surface 106, and to determine any actions carried out by the pointer, such as selection of an icon. The computer 110 then updates the displayed image projected through the projector 102 in dependence upon detection of action of the pointer 108.

The invention is now described by way of reference to exemplary embodiments.

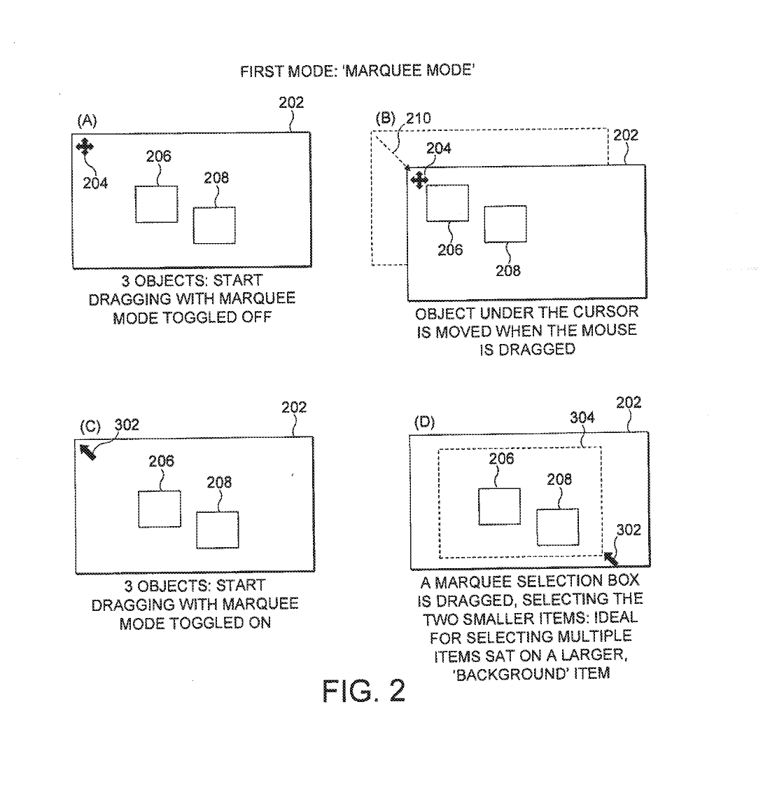

The principles of embodiments of the present invention will now be illustrated by way of example with reference to FIGS. 2 to 4.

Embodiments of the invention provide for first, second and third modes of operation. Each mode toggles between one of two states. In one state the mode of operation is selected (or enabled), and in another state the mode of operation is deselected (or disabled).

Preferably, the toggling between the two states of a mode of operation is achieved by displaying on the display screen an icon associated with the graphical user interface. By selecting the icon a user can switch or toggle between the two states of the mode of operation. Thus the mode of operation is always either enabled or disabled.

This is particularly advantageous in an interactive display system, where a user interacts with the display surface. The user may use a pointer, for example, to select the displayed icon and toggle between the two states of the mode of operation.

The toggling between states may be achieved in other ways. For example in an interactive display system a button provided on a pointing device may be selected to toggle between states. In certain embodiments, a key or a keyboard may be depressed to toggle between states.

With respect to FIGS. 2a to 2d the first mode of operation is described.

With respect to FIGS. 2a and 2b, the first state of the first mode of operation is described. In FIG. 2a there is illustrated an object 202. Within the object 202 there is positioned two further objects denoted by reference numerals 206 and 208. As can be seen in FIG. 2a, an icon 204 representing a cursor position is located above the object 202. In use, the user places a pointer on the interactive display surface at the cursor location 204, and drags the cursor to a new position as denoted by dash line 210 in FIG. 2b. In the first state of the mode of operation, this action results in the object 202 over which the cursor 204 is placed being moved to a new location. The objects 206 and 208 remain in their locations. Thus in this first state of the mode of operation, the object under the cursor is moved when the pointer drags the cursor.

The operation of the second state of the first mode of operation is described with reference to FIGS. 2c and 2d. In FIG. 2c, as in FIG. 2a, the cursor 302 is located over the object 202. As with FIG. 2a, in FIG. 2c the objects 206 and 208 are located within the object 202. As in the arrangement of FIGS. 2a and 2b, the pointer is located in the position of the cursor 302 as shown in FIG. 2c, and then moved to a new position, i.e. is dragged across the display surface as shown in FIG. 2d.

In the second state of the first mode of operation the dragging of the cursor from one position to another position creates a selection box, as denoted by dash-line rectangular box 304 in FIG. 2d. In the example of FIG. 2d, the cursor 302 is moved such that the selection box 304 wholly encompasses the objects 206 and 208. In this second state of the first mode of operation, the cursor may thus be dragged to select one or more items which are positioned on a larger background item.

Thus it can be understood, from the description of FIG. 2, that in an embodiment a pointer may be used to select a state of a first mode of operation which is represented by a displayed icon, by selecting the icon to toggle between the two states of the mode.

It should be understood that while embodiments of the invention are particularly advantageous for use in interactive display systems where the user interacts with an interactive surface using a pointing means, it is not limited to such. The invention may still be implemented in an arrangement where a mouse or other input device is used in association with a computer to control a cursor on a display screen, the mouse or other input device being used to control the cursor to toggle between states.

This first mode of operation, switchable between two states, as described above with reference to FIGS. 2a and 2b may be referred to as “marquee mode”. When the mode is in the second state, a marquee or selection box is dragged from the starting point of the cursor to the end point of the cursor. When the mode is in the first state, and thus effectively disabled, the default behaviour is observed whereby the object which the cursor overlies is moved.

It should be noted that whilst reference is made to a marquee or selection ‘box’, in embodiments different shapes may be created by dragging the cursor, such as a lasso shape. In general, there is created a marquee or selection area or shape.

The described first mode of operation, switchable between two states, is a new mode of operation. In the prior art, moving the cursor as shown in FIG. 2 will always result in the object underneath the cursor—if there is an object underneath the cursor—being dragged. In an exemplary embodiment, as described, the function can be changed to drag a marquee selection box even if there is an object underneath the cursor. As described, the function preferably toggles between the two states.

In a further embodiment a second mode of operation also having two states is provided, in addition to the mode described above. As with the mode described above, in one state this mode is enabled, and in the other state it is disabled. This further mode of operation may be referred to as a “crossing mode” of operation. As with the first mode, an icon may be displayed on the display screen which can be selected by the mouse, selecting the icon toggling the mode between a first and second state, being enabled and disabled states.

When toggled on, in this second mode of operation any items which cross or intersect the marquee selection area, when marquee mode is enabled, will be selected. When toggled off, only those items which are completely enclosed by the marquee selection area will be included in the selection.

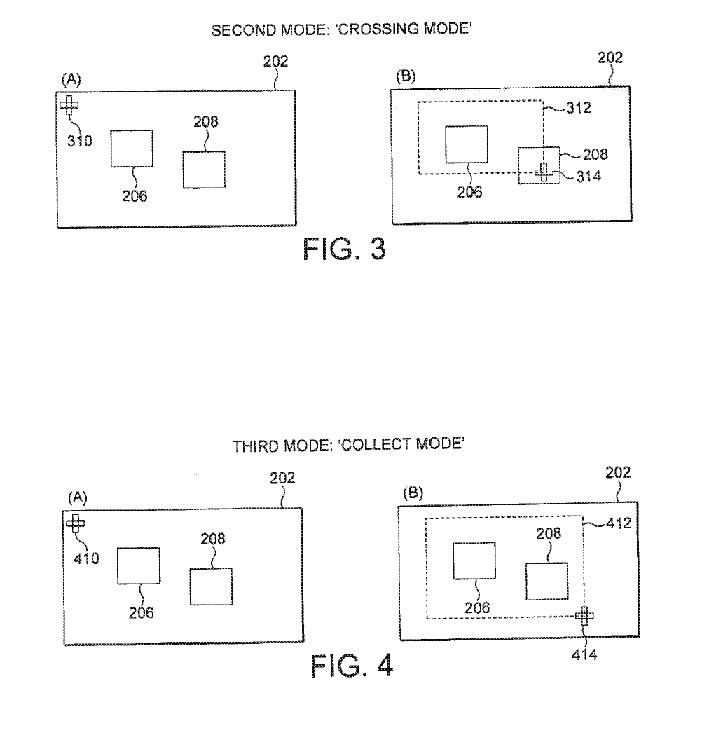

The second (crossing) mode of operation can be further understood with reference to FIG. 3. FIG. 3a corresponds to FIG. 2a. The initial cursor position is denoted by reference numeral 310. The cursor is dragged across the display to a position 314, and as a result a selection area 312 is created as illustrated in FIG. 3b.

As can be seen in FIG. 3b, the position 314 of the dragged cursor is such that the selection area crosses the object 208, and only the object 206 is wholly encompassed within the selection area 312.

With the second mode of operation enabled in the first state, the object 208 is selected by the selection area. With the second mode of operation disabled in the second state, the object 208 is not selected by the selection area.

In one arrangement, for the object to be wholly encompassed within a selection area, its entire area and edges must be within the selection area.

Thus this additional second mode of operation is preferably provided as an augmentation to the marquee mode of operation described above. However this second mode of operation, the crossing mode, may also be provided independently of the first (marquee) mode as a stand-alone mode.

A third mode of operation, referred to as “collect mode”, may preferably be implemented as a further augmentation, either for the marquee mode or the crossing mode (or both). However the third (collect) mode may also be provided independently of the first (marquee) or second (crossing) modes.

For this third mode of operation, again two states are provided which can be toggled between, in one state the mode being enabled and in the other state the mode being disabled. As with the modes described above, an icon may be displayed on the display screen associated with this mode, selection of the icon toggling between the two states.

The third (collect) mode of operation can be further understood with reference to FIG. 4. FIG. 4a corresponds to FIG. 2a. The initial cursor position is denoted by reference numeral 410. The cursor is dragged across the display to a position 414, and as a result a selection area 412 is created as illustrated in FIG. 4b.

As can be seen in FIG. 4b, the selection area 412 encompasses the objects 206 and 208.

With the third mode of operation enabled, in the first state, the selected objects 206 and 208 are added to a previous selection of objects or, if already in that previous selection, removed from a previous selection of objects. With the third mode of operation disabled, in the second state, the selected objects 206 and 208 replace any previously selected objects.

When this third mode is enabled, the behaviour is to add items to the selection in the first mode, or remove items if they are currently selected, rather than replacing the current selection with a new item as in the second mode.

Whilst this third mode is described as requiring a selection area to select objects, this is an exemplary arrangement. An object may be selected, in addition or as an alternative, by ‘clicking on’ the object: i.e. moving the cursor over the object and using the selection mechanism provided by the system, such as depressing a pointer on an interactive surface.

This third mode of operation, when enabled, is as if the control key on a Windows system (or the command key on an Apple system) is being held down whilst the cursor is being moved.

This allows a functionality to be selected for a user operating at the display surface of an interactive display, which functionality can advantageously be selected without having to additionally use a key(s) of a keyboard. In the prior art, it is known to implement a function for providing a collect mode on dragging of a mouse by holding down a control key on a keyboard while dragging the mouse. Thus in the prior art the collect mode of operation is known, the selection between states of the collect mode of operation being achieved by selecting a key of a keyboard in addition to operating the mouse.

Thus in this mode of operation, the behaviour matches that which can be achieved when a keyboard is available, by holding down the control key on Windows and the command key on Apple Macintosh operating systems. Where a keyboard is not available, such as when stood at an interactive display surface, this option is particularly valuable.

In the third mode of operation, there is thus presented an example where toggling between states for a particular function enables simulation of the ‘control key’ on a keyboard being depressed.

Preferably this does not emulate to the operating system that the ‘control key’ is depressed. Rather the software application is adapted to respond to the toggling into the given state to enable the same functionality as would be enabled by the ‘control key’ being depressed. The toggling between states is achieved using the user interface rather than the ‘control key’.

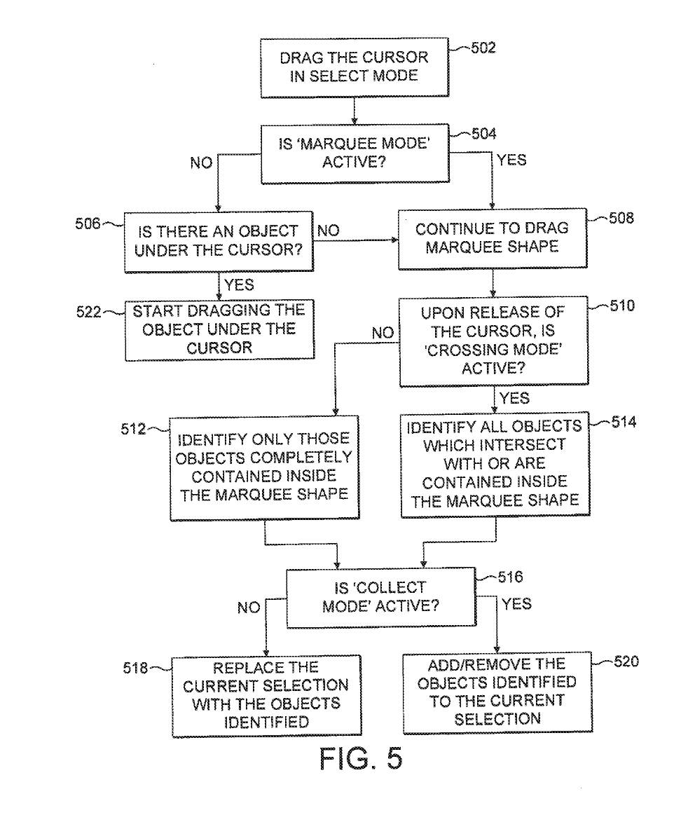

With reference to FIG. 5, there is illustrated a flow diagram for processing the inputs from the interaction of the display surface with the pointer, in order to determine whether any of the three described modes are enabled, and taking the appropriate action in accordance with their state in an exemplary embodiment in which all three of the above-described modes of operation are implemented.

FIG. 5 illustrates the logic path which would be followed in an exemplary implementation, where all three modes of described operation are enabled. However each of the three modes can be implemented independently, or can be implemented in any combination. When implemented in combination, the modes of operation need not be restricted to the preferable order shown in FIG. 5.

In step 502, a cursor is dragged on the display from a first position to a second position. This corresponds to the dragging of the cursor as shown in FIGS. 2, 3 and 4 above.

In step 504, it is then determined whether the first mode, marquee mode, is active. This is determined by the state of the mode. If the state is such that the marquee mode is not active, then in a step 506 it is determined whether there is an object under the cursor. If there is an object under the cursor, then in a step 522 that object is dragged. The final position of the object corresponds to the point at which the cursor dragging is stopped.

If in step 506 it is determined that there is no object under the cursor, then in a step 508 a marquee shape, or selection area, is formed by the dragging of the cursor.

If in step 504 it is determined that marquee mode is active, determined by the appropriate state, then in step 508 the marquee shape, or selection area, is formed by the dragging of the cursor.

Upon release of the cursor following step 508, a selection area is defined. In a step 510 it is determined whether the second mode, being the crossing mode, is active. This is determined in accordance with the state of the crossing mode.

If it is determined that the crossing mode is not active, then in a step 512 only those objects which are determined to be contained inside the marquee shape or selection area are identified. As noted above, this determination may be made in a number of ways.

On the other hand, if it is determined in step 510 that the crossing mode is active, then in a step 514 all objects which are completely contained inside the selection area, and those which intersect with the selection area, are identified.

The identified objects then form a selection set, being the objects which have been selected as a result of the marquee mode of operation. The crossing mode of operation determines whether the marquee mode of operation selects only those objects which are determined to be contained within the selection area, or those which are determined to be not contained within the selection area (i.e. those which cross with the selection area).

After either of steps 512 or 514, in a step 516 it is determined whether the third mode of operation, being the collect mode, is active. Whether this mode is active is determined by the state of the mode of operation.

If it is determined that the collect mode is not active, then in a step 518 the object(s) selected by the selection area become the selection set. Any previously selected items are unselected, and the only selected items are those which have now been selected in the current selection area.

If it is determined that in step 516 the collection mode is active, then in a step 520 the objects selected in the selection area are added to or removed from the selection set. If an object in the current selection area is already part of the selection set, i.e. is already a selected object, then it is removed from the selection set. If an object identified in the current selection area is not part of the current selection set, then it is added to the selection area. In a step 520, therefore, the selection of the objects for the selection set are toggled in dependence upon whether they are selected in the current selection area. Thus an existing set of selected objects is modified in dependence on the objects identified in the current selection area.

With respect to the third mode of operation in the exemplary arrangement where it is combined with the first and second modes, the object selection is preferably determined by the selection area. In other arrangements the object selection, in the third mode, may simply be by selection of an object without a selection area.

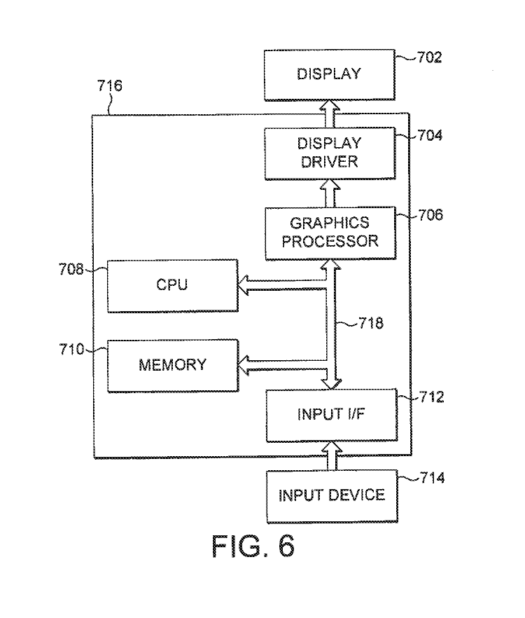

With reference to FIG. 6, there is illustrated an exemplary computer system architecture including means for implementing embodiments of the invention. The computer system is generally designated by reference numeral 716. The computer system includes a central processor unit (CPU) 708, a memory 710, a graphics processor 706, a display driver 704, and an input interface 712. The graphics processor 706, CPU 708, memory 710, and input interface 712 are interconnected via an interface bus 718. The graphics processor 706 connects to the display driver 704 via a graphics bus 720. The display driver 704 is connected to a display 702 associated with the computer system via an interface 722. The input interface 712 receives input signals on an interface 724 from an input device (or devices) 714.

The display 702 may be integrated with the computer system or be external to the computer system. The display 702 may be, for example, a display of an interactive display system. The input device 714 may be integrated with the computer system or external thereto. The input device 714 may be a pointing device associated with an interactive display surface.

In other exemplary arrangements, the display 702 may be an integrated display of a personal data system (PDA) device or other form of portable computer system. The input device 714 may be an integrated keypad of a PDA, a keyboard associated with a computer system, or a touch surface. One skilled in the art will appreciate the possible options for providing inputs to different types of computer system, and for displaying data from different types of computer system.

The methods described hereinabove may be implemented on computer software running on a computer system. The invention may therefore be embodied as computer program code being executed under the control of a processor of a computer system. The computer program code may be stored on a computer program product. A computer program product may include a computer memory, a portable disk or portable storage memory, or hard disk memory.

The invention is described herein in the context of its application to a computer system forming part of an interactive display system. It will be understood by one skilled in the art that the principles of the invention, and the embodiments described herein, are not however limited to an interactive display system. The principles of the invention and its embodiments may be implemented in any computer system including a display and a user interface. The invention and its embodiments is also not limited to the use of a pointer or touch surface type arrangement in order to move a cursor on a display. The invention encompasses any technique for the movement of a cursor, including the movement of a cursor using a conventional computer mouse.

The invention has been described herein by way of reference to particular examples and exemplary embodiments. One skilled in the art will appreciate that the invention is not limited to the details of the specific examples and exemplary embodiments set forth. Numerous other embodiments may be envisaged without departing from the scope of the invention, which is defined by the appended claims.

1. A method of controlling a user interface comprising the steps of:
positioning a cursor over a displayed object and dragging the cursor; and
determining a state of a mode of operation, wherein:
in a first state, the object under the cursor is dragged with the cursor; and
in a second state, a selection area is dragged with the cursor.

2. The method according to claim 1 wherein the selection area is a marquee selection box.

3. The method according to claim 1 wherein in said second state any item which intersects the selection area is selected.

4. The method according to claim 1 wherein in said second state any item which is contained within the selection area is selected.

5. The method according to claim 1 wherein the mode of operation is toggled between the first and second states.

6. The method of claim 5 wherein the state of said mode is toggled by selection of any one of: an icon of a graphical user interface; a keypad of a keyboard; or a button of a pointing device.

7. A method according to claim 1 comprising determining the state of a further mode of operation when a selection area is formed, comprising:
in a first state of said further mode, any object selected by the selection area replaces one or more previously selected objects;
in a second state of said further mode, any object selected by the selection area is added to or removed from a selection set.

8. A method according to claim 7 wherein in the second state of the further mode if an object selected by the selection area is already in said selection set, it is removed from said selection set.

9. A method according to claim 7 wherein in the second state of the further mode if an object selected by the selection area is not in said selection set, it is added to said selection set.

10. A method according to claim 1 wherein the cursor is controlled by a pointer on an interactive display surface.

11. A computer program product for storing computer program code which, when executed on a computer, performs the method of claim 1.

12. A computer program for execution on a computer system to perform the method of claim 1.

13. A computer system adapted to:
position a cursor over a displayed object and dragging the cursor; and
determine a state of a mode of operation, wherein:
in a first state, the object under the cursor is dragged with the cursor; and
in a second state, a selection area is dragged with the cursor.

14. A method of controlling a user interface comprising the step of:
defining a selection set, being a set of one or more selected objects;
selecting an object; and
determining a state of a mode of operation, wherein:
in a first state any selected object forms the selection set; and
in a second state any selected object is added to or moved from the selection set.

15. A method according to claim 14 wherein the step of selecting an object comprises:
dragging a cursor on a display over one or more displayed objects to define a selection area;
and wherein the steps of determining the state of the mode of operation includes:
in the first state any object determined to be in the selection area forms the selection set;
in the second state any object determined to be in the selection area is added to or removed from the selection set.

16. A method according to claim 14 5 wherein in the second state any selected object determined to be in the selection set is removed from the selection set.

17. A method according to claim 14 wherein in the second state any selected object determined to not be in the selection set is added to the selection set.

18. A method according to claim 14 wherein in the first state any selected object replaces any object in the selection set.

19. A method according to claim 15 wherein any object which is encompassed by the selection area is defined to be in the selection area.

20. A method according to claim 15 wherein any object which intersects the selection area is defined to be in the selection area.

21. A method according to claim 14 further comprising the step of determining a state of a preliminary mode of operation, wherein in a first state of said preliminary mode of operation an object under the cursor is dragged as the cursor is dragged, and in a second state of said preliminary mode of operation the selection area is defined.

22. A computer program product for storing computer program code which, when executed on a computer system, performs the method of claim 14.

23. A computer program for execution on a computer system to perform the method of claim 14.

24. A computer system adapted to:
define a selection set, being a set of one or more selected objects;
select an object; and
determine a state of a mode of operation, wherein:
in a first state any selected object forms the selection set; and
in a second state any selected object is added to or moved from the selection set.
